(19) United States
(12) Patent Application Publication
(10) Pub. No.: US 2018/0100473 A1
(43) Pub. Date: Apr. 12, 2018

(54) INTAKE SYSTEM COMPONENT

(71) Applicant: TOYOTA BOSHOKU KABUSHIKI KAISHA, Aichi-ken (JP)

(72) Inventor: Ryusuke KIMURA, Ichinomiya-shi (JP)

(73) Assignee: TOYOTA BOSHOKU KABUSHIKI KAISHA, Aichi-ken (JP)

(21) Appl. No.: 15/717,318

(22) Filed: Sep. 27, 2017

(30) Foreign Application Priority Data
Oct. 11, 2016 (JP) 2016-200118

(51) Int. Cl. F02M 35/12

(52) U.S. Cl. CPC F02M 35/1272; F02M 35/10334; F02M 35/1266

(57) ABSTRACT

An intake system component arranged in an engine compartment of a vehicle includes a side wall that forms an intake passage. The side wall includes a non-breathable layer, an inner noise absorption layer, and an outer noise absorption layer. The non-breathable layer is formed from a non-breathable material. The inner noise absorption layer is located at an inner side of the non-breathable layer and formed from a breathable material. The outer noise absorption layer is located at an outer side of the non-breathable layer and formed from a breathable material.

### BACKGROUND OF THE INVENTION

The present invention relates to an intake system component.

In a vehicle such as an automobile, an intake system component (e.g., intake duct) including side walls that define an intake passage is arranged in an engine compartment. It is desirable that the intake noise be reduced in such an intake duct (intake passage). Japanese Laid-Open Patent Publication No. 11-343939 describes an intake duct having breathable side walls that release acoustic pressure from the intake duct (intake passage). This reduces intake noise by limiting the generation of standing waves resulting from the intake noise in the intake duct.

When the vehicle engine is running, the engine also generates noise that affects the noise in the engine compartment. It is thus desirable that the noise produced outside the intake passage be reduced in addition to the noise produced inside the intake passage in the engine compartment. However, when arranging an intake duct such as that described in the above publication in the engine compartment, the acoustic pressure of the intake noise is released from the intake duct (intake passage) in the engine compartment. This is a disadvantage when attempting to reduce noise in the engine compartment. In order to reduce the noise produced in the engine compartment, a noise-reducing device or noise-reducing member needs to be arranged in the engine compartment. However, such a device or member will occupy a large space in the engine compartment.

### SUMMARY OF THE INVENTION

It is an object of the present invention to provide an intake system component that reduces noise in the engine compartment without occupying a large space in the engine compartment.

To achieve the above object, an intake system component arranged in an engine compartment of a vehicle includes a side wall that forms an intake passage. The side wall includes a non-breathable layer formed from a non-breathable material, an inner noise absorption layer located at an inner side of the non-breathable layer and formed from a breathable material, and an outer noise absorption layer located at an outer side of the non-breathable layer and formed from a breathable material.

With the above structure, in the intake system component of the engine compartment, the non-breathable layer, which is formed from a non-breathable layer, separates the side wall, which forms the intake passage, into the inner noise absorption layer and the outer noise absorption layer. The inner noise absorption layer reduces intake noise in the intake passage. The outer noise absorption layer reduces noise outside the intake passage in the engine compartment.

When the intake noise in the intake passage enters the inner noise absorption layer in the side wall of the intake system component, the breathable material forming the inner noise absorption layer finely oscillates. This converts the energy of the intake noise into motion of the breathable material and consumes the energy. The energy consumption reduces (absorbs) the intake noise. The non-breathable layer of the side wall isolates the intake passage from the engine compartment. Thus, the non-breathable layer limits the entrance of intake noise from the intake passage to the engine compartment, and the reduction of noise in the engine compartment is not hindered by intake noise from the intake passage.

When the noise in the engine compartment enters the outer noise absorption layer in the side wall of the intake system component, the breathable material forming the outer noise absorption layer finely oscillates. This converts the energy of the noise into motion of the breathable material and consumes the energy. The energy consumption reduces (absorbs) the noise. Thus, there is no need to arrange a noise-reducing device or a noise-reducing member in the engine compartment, and there is no need to provide a large space in the engine compartment for such a device or member.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic diagram illustrating an intake system of an internal combustion engine in an engine compartment of a vehicle;

FIG. 2 is a perspective view showing an intake duct of the intake system illustrated in FIG. 1;

FIG. 3 is a cross-sectional view of a fibrous portion in the intake duct shown in FIG. 2 taken along a radial direction; and

FIG. 4 is a schematic perspective view showing the structure of a side wall in the fibrous portion of FIG. 3.

### DETAILED DESCRIPTION OF THE PREFERRED EMBODIMENTS

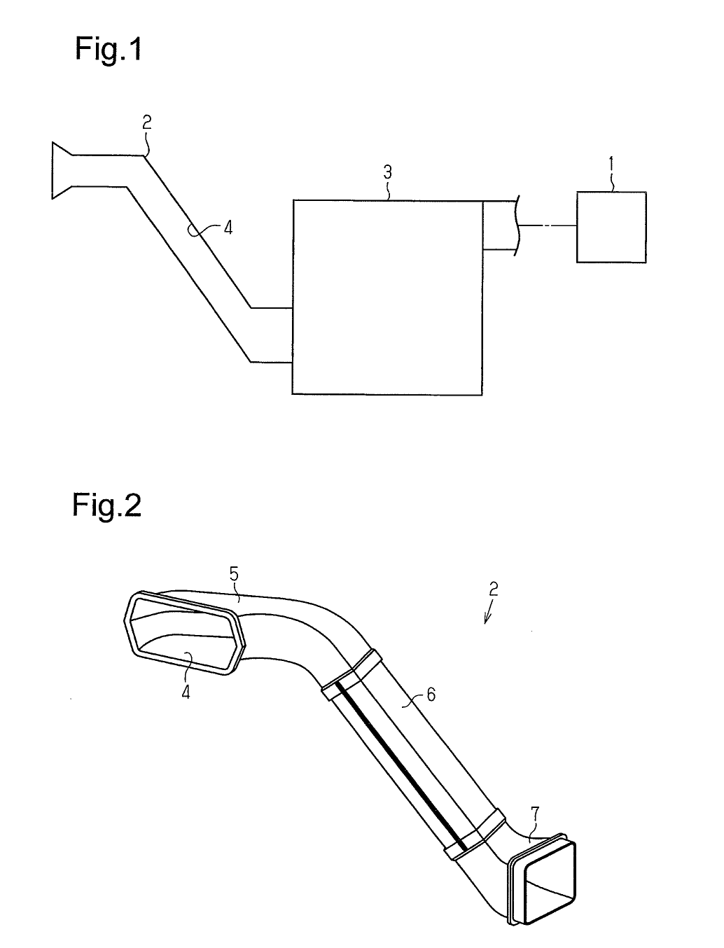

One embodiment of an intake system component arranged in an engine compartment of a vehicle will now be described with reference to FIGS. 1 to 4. In the description hereafter, the term “inner side” will refer to the side of a subject closer to the center of a fibrous portion 6, and the term “outer side” will refer to the side of a subject farther from the center of the fibrous portion 6.

FIG. 1 schematically shows an intake system of an internal combustion engine 1 installed in an engine compartment of a vehicle. The intake system of the internal combustion engine 1 includes intake system components such as an intake duct 2 and an air cleaner 3 that form an intake passage 4. Air is drawn through the intake passage 4 into the internal combustion engine 1. The intake duct 2 is connected to the air cleaner 3 and located at the upstream side of the air cleaner 3 in the intake system of the internal combustion engine 1.

As shown in FIG. 2, the intake duct 2 includes a resin portion 5, the fibrous portion 6, and a resin portion 7 that are arranged from the upstream side toward the downstream side. The intake passage 4 extends inside the resin portion 5, the fibrous portion 6, and the resin portion 7 that are connected to one another. The resin portion 5 and the resin portion 7 are formed from a resin, and the fibrous portion 6 is formed by sheets of a non-woven fabric.

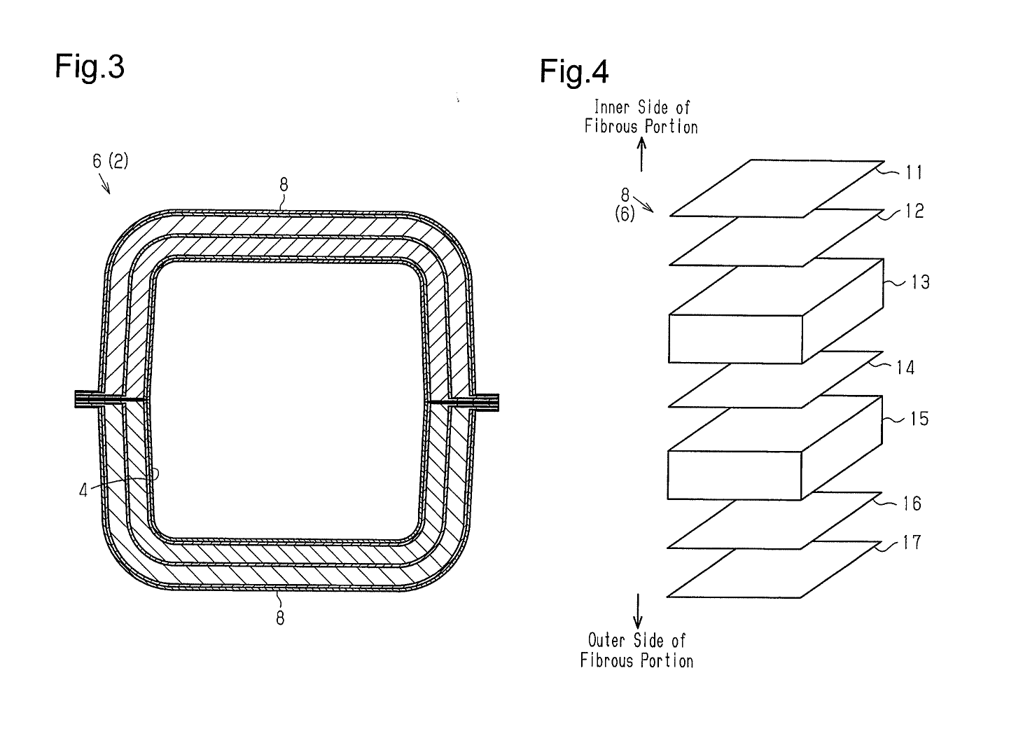

FIG. 3 shows the cross section of the fibrous portion 6 in the intake duct 2. The fibrous portion 6 includes a pair of side walls 8, namely, an upper side wall 8 and a lower side wall 8 that form the intake passage 4. The two edges of one side wall 8 in the radial direction of the fibrous portion 6 are joined with the two edges of the other side wall 8 in the radial direction of the fibrous portion 6. This forms the intake passage 4 between the side walls 8.

As shown in FIG. 4, each side wall 8 of the fibrous portion 6 includes a coating 11, a breathable film 12, a noise absorbent 13, a non-breathable film 14, a noise absorbent 15, a breathable film 16, and a coating 17. The elements of the side wall 8 are stacked in the thickness-wise direction of the side wall 8 from the upper side toward the lower side as viewed in FIG. 4 (from inner side toward outer side of fibrous portion 6 as viewed in FIG. 3) in the order of the coating 11, the breathable film 12, the noise absorbent 13, the non-breathable film 14, the noise absorbent 15, the breathable film 16, and the coating 17.

The non-breathable film 14 of each side wall 8 functions as a non-breathable layer formed from a non-breathable material. Further, the noise absorbent 13 functions as an inner intake layer formed from a breathable material such as sheets of a non-woven fabric at the inner side of the non-breathable layer (non-breathable film 14). The noise absorbent 15 functions as an outer intake layer formed from a breathable material such as sheets of a non-woven fabric at the outer side of the non-breathable layer (non-breathable film 14). The coating 11 and the breathable film 12 function as an inner coating layer formed from a breathable material having lower breathability than an inner noise absorption layer (noise absorbent 13) and located on an inner surface of the inner noise absorption layer. The breathable film 16 and the coating 17 function as an outer coating layer formed from a breathable material having lower breathability than an outer noise absorption layer (noise absorbent 15) and located on an outer surface of the outer noise absorption layer.

In each side wall 8, when noise enters the inner noise absorption layer (noise absorbent 13) and the outer noise absorption layer (noise absorbent 15), the noise finely oscillates the fibers of the non-woven fabric sheets forming the noise absorbents 13 and 15. In this manner, the conversion of acoustic energy into the motion of the fibers consumes the acoustic energy. The energy consumption reduces high-frequency band components from the noise and reduces (absorbs) noise.

Further, when noise enters the inner and outer coating layer of each side wall 8, the noise is reduced by resonance that occurs at the inner coating layer and resonance that occurs at the outer coating layer.

More specifically, when noise enters the inner coating layer (coating 11 and breathable film 12), the inner coating layer resonates. The resonation produces oscillation resulting in inner friction that heats the inner coating layer. This means that the acoustic energy is consumed when converted to heat. The energy consumption reduces noise components corresponding to the resonance frequency of the inner coating layer. The resonance frequency of the inner coating layer is correlated with the breathability of the inner coating layer (breathable film 12) and decreases as the breathability decreases. The breathability of the breathable film 12 is lower than the breathability of the noise absorbent 13. Thus, the resonance frequency of the inner coating layer is in the low-frequency band. As a result, when noise enters the inner coating layer, the inner coating layer resonates and reduces the low-frequency band components in the noise.

When noise enters the outer coating layer (breathable film 16 and coating 17), the outer coating layer resonates. The resonation produces oscillation resulting in inner friction that heats the outer coating layer. This means that the acoustic energy is consumed when converted to heat. The energy consumption reduces noise components corresponding to the resonance frequency of the outer coating layer. The resonance frequency of the outer coating layer is correlated with the breathability of the outer coating layer (breathable film 16) and decreases as the breathability decreases. The breathability of the breathable film 16 is lower than the breathability of the noise absorbent 15. Thus, the resonance frequency of the outer coating layer is in the low-frequency band. As a result, when noise enters the outer coating layer, the outer coating layer resonates and reduces the low-frequency band components in the noise.

The elements of each side wall 8 will now be described in detail.

Non-Breathable Film 14

The weight and thickness of the non-breathable film 14 are in ranges that block noise at the outer side and inner side of the fibrous portion 6 while keeping the fibrous portion 6 as light as possible. In detail, the weight of the non-breathable film 14 may be set to 5 to 300 g/m² (square meters), and the thickness of the non-breathable film 14 may be set to 0.01 to 3 mm. In this embodiment, the weight of the non-breathable film 14 is set to, for example, 20 g/m².

Noise Absorbents 13 and 15

The noise absorbents 13 and 15 are fibrous bodies formed by thermally pressing non-woven fabric sheets of a breathable material. The non-woven fabric sheets are formed from core-sheath type composite fibers, each including a core, formed from, for example, polyethylene terephthalate (PET) fibers, and a sheath, formed from modified PET that has a lower melting point than the PET fibers. The diameter of the fibers in the non-woven fabric sheets and the weight and thickness of the noise absorbents 13 and 15 are in ranges that obtain the noise-reducing properties required for the noise absorbents 13 and 15 while minimizing the weight of the noise absorbents 13 and 15. More specifically, the fiber diameter of the non-woven fabric sheets is 11 to 25 μm. The weight of each of the noise absorbents 13 and 15 can be set to, for example, 50 to 1000 g/m². In this embodiment, the weight of each of the noise absorbents 13 and 15 is set to 600 g/m². Further, the thickness of each of the noise absorbents 13 and 15 can be set to 5 to 50 mm and more preferably 11 to 25 mm.

Breathable Films 12 and 16

The breathable films 12 and 16 of the inner and outer coating layers have a lower breathability than the noise absorbents 13 and 15. Further, the breathability of the breathable films 12 and 16 are in ranges that effectively reduce noise in a frequency band that is lower than the frequency band of the noise reduced by the noise absorbents 13 and 15. In detail, the breathable films 12 and 16 have a breathability (JIS L 1096, A method (Frazier method)) of 3 to 50 cc/cm² (square centimeters)·s and, more preferably, 5 to 10 cc/cm²·s.

Coatings 11 and 17

The coatings 11 and 17 of the inner and outer coating layers are formed by non-woven fabric sheets formed by PET fibers.

The weight and thickness of the inner coating layer formed by the coating 11 and the breathable film 12 are in ranges that effectively reduce noise in a frequency band that is lower than the frequency band of the noise reduced by the noise absorbent 13. More specifically, the weight of the inner coating layer is 20 to 1000 g/m², and the thickness of the inner coating layer is 0.1 to 5 mm. In this embodiment, the weight of the breathable film 12 is 45 g/m², and the weight of the coating 11 is 70 g/m².

The weight of the outer coating layer formed by the breathable film 16 and the coating 17 are in ranges that effectively reduce noise in a frequency band that is lower than the frequency band of the noise reduced by the noise absorbent 15. More specifically, the weight of the outer coating layer is 20 to 1000 g/m², and the thickness of the outer coating layer is 0.1 to 5 mm. In this embodiment, the weight of the breathable film 16 is 45 g/m², and the weight of the coating 17 is 70 g/m².

The operation of the intake duct 2 will now be described.

The fibrous portion 6 of the intake duct 2 in the engine compartment is formed by joining the two side walls 8, and the intake passage 4 is formed between the side walls 8. In each side wall 8, the non-breathable film 14 (non-breathable layer) separates the noise absorbent 13 (inner noise absorption layer), which reduces the intake noise of the intake passage 4, from the noise absorbent 15, which reduces the noise of the engine compartment outside the intake passage 4.

When intake noise in the intake passage 4 enters the noise absorbent 13 in each side wall 8, the noise absorbent 13 reduces high-frequency band components in the intake noise. Further, the inner coating layer resonates when the intake noise enters the inner coating layer and reduces high-frequency band components in the intake noise that have a great influence. The non-breathable film 14 in each side wall 8 isolates the inside of the intake passage 4 from the inside of the engine compartment. Thus, the non-breathable film 14 restricts the passage of intake noise from the intake passage 4 to the engine compartment. Accordingly, the intake noise of the intake passage 4 does not hinder the reduction of noise in the engine compartment.

When noise in the engine compartment enters the noise absorbent 15 in each side wall 8, the noise absorbent 15 reduces high-frequency band components in the noise. Further, the outer coating layer resonates when the noise enters the outer coating layer and reduces low-frequency band components in the noise that have a great influence. Accordingly, there is no need for a noise-reducing device or noise-reducing member to be arranged in addition to the intake duct 2 in the engine compartment, and there is no need to provide a large space in the engine compartment for such a device or member.

The present embodiment has the advantages described below.

(1) The side walls 8 of the intake duct 2 (fibrous portion 6) forming the intake passage 4 reduce the noise produced in the engine compartment in addition to the intake noise produced in the intake passage 4. Thus, noise can be reduced in the engine compartment without a noise-reducing device or noise-reducing member that would occupy a large space in the engine compartment.

(2) The non-breathable film 14 serves as a non-breathable layer that separates the noise absorbent 13 and the noise absorbent 15. This facilitates the formation of a non-breathable layer with the side walls 8.

(3) The side walls 8 each include the inner coating layer. Thus, in addition to the noise absorbent 13 reducing high-frequency components in the intake noise produced in the intake passage 4, the inner coating layer (coating 11 and breathable film 12) reduces low-frequency components in the intake noise that have a great influence.

(4) The side walls 8 each include the outer coating layer. Thus, in addition to the noise absorbent 15 reducing high-frequency components in the noise produced in the engine compartment, the outer coating layer (breathable film 16 and coating 17) reduces low-frequency components in the noise that have a great influence.

It should be apparent to those skilled in the art that the present invention may be embodied in many other specific forms without departing from the spirit or scope of the invention. Particularly, it should be understood that the present invention may be embodied in the following forms.

Instead of applying the present invention to the intake duct 2 that is arranged in the intake system of the internal combustion engine 1, the present invention may be applied to an intake system component forming an air passage (intake passage) used to deliver air to a fuel cell.

When the internal combustion engine 1 is running, intake pulsation is generated in the intake passage 4 of the intake system of the engine 1. The intake pulsation generates standing waves based on intake noise in the intake passage 4. The generation of such standing waves results in the increase of intake noise. However, standing waves resulting from intake pulsation are not generated in the air passage that delivers air to a fuel cell.

In this regard, the reduction of noise by the coating 11, the breathable film 12, and the noise absorbent 13 in each side wall 8 of the intake duct 2 is realized by the noise absorption performed by the noise absorption layer (noise absorbent 13) and the resonance of the inner coating layer (coating 11 and breathable film 12). In other word, according to the present invention, the reduction of noise is not realized by releasing acoustic pressure from the intake duct 2 and there is no need to limit the generation of standing waves.

Thus, the intake duct 2 reduces intake noise regardless of whether or not standing waves exist. Accordingly, intake noise of the air passage can be reduced even when using the intake duct 2 as the intake system component that forms an air passage where standing waves are not generated.

Instead of applying the present invention to the intake duct 2, the present invention may be applied to the air cleaner 3 or a duct located downstream from the air cleaner 3 and connected to the air cleaner 3.

The present examples and embodiments are to be considered as illustrative and not restrictive, and the invention is not to be limited to the details given herein, but may be modified within the scope and equivalence of the appended claims.

1. An intake system component arranged in an engine compartment of a vehicle, the intake system component comprising:
a side wall that forms an intake passage, wherein the side wall includes
a non-breathable layer formed from a non-breathable material,
an inner noise absorption layer located at an inner side of the non-breathable layer and formed from a breathable material, and
an outer noise absorption layer located at an outer side of the non-breathable layer and formed from a breathable material.

2. The intake system component according to claim 1, wherein the non-breathable layer includes a non-breathable film having a thickness of 0.01 to 3 mm and a weight of 5 to 300 g/m².

3. The intake system component according to claim 1, wherein the inner noise absorption layer and the outer noise absorption layer each have a thickness of 5 to 50 mm and a weight of 50 to 1000 g/m².

4. The intake system component according to claim 1, wherein
the side wall further includes an inner coating layer and an outer coating layer,
the inner coating layer is located on an inner surface of the inner noise absorption layer and formed from a breathable material having a lower breathability than the inner noise absorption layer, and
the outer coating layer is located on an outer surface of the outer noise absorption layer and formed from a breathable material having a lower breathability than the outer noise absorption layer.

5. The intake system component according to claim 4, wherein the inner coating layer and the outer coating layer each have a breathability of 5 to 10 cc/cm²·s, a weight of 20 to 1000 g/m², and a thickness of 0.1 to 5 mm.
